(19) United States
(12) Patent Application Publication
(10) Pub. No.: US 2025/0010958 A1
(43) Pub. Date: Jan. 9, 2025

(54) AIR-LIQUID DUAL CONTROL ANTI-ROLLING CONTROL SYSTEM FOR FLOATING OFFSHORE WIND TURBINE IN OFFSHORE DEEP SEA

(71) Applicants: DALIAN UNIVERSITY OF TECHNOLOGY; DONGHAI LABORATORY

(72) Inventors: Chongwei ZHANG, Dalian (CN); Jindie WEI, Dalian (CN); Xunhao ZHU, Dalian (CN); Dezhi NING, Dalian (CN)

(21) Appl. No.: 18/279,737

(22) PCT Filed: Dec. 5, 2022
(86) PCT No.: PCT/CN2022/136427

§ 371 Date: Aug. 31, 2023

(51) Int. Cl. B63B 39/03; B63B 1/12; B63B 21/50; B63B 35/44; F03D 13/25

(52) U.S. Cl. CPC B63B 39/03; B63B 1/125; B63B 21/50; B63B 35/44; F03D 13/256; B63B 2035/446; F05B 2240/93; F05B 2240/95

(57) ABSTRACT

An air-liquid dual control anti-rolling control system for a floating offshore wind turbine in offshore deep sea comprises an equipment compartment and three closed TLCD loop units. The equipment compartment is arranged above box girders; and each TLCD loop unit mainly forms a closed loop by a liquid tank, an air tube and a liquid tube and is embedded into the structure of a floating foundation. The system of the present invention has simple structure, easy installation, detachability, easy replacement and convenient use. The system of the present invention has universality, the designed TLCD loop units are independent of each other, and the start and stop of each TCLD loop unit is entirely coordinated and scheduled by a control module, which is easy to expand. The system of the present invention can realize intelligent autonomous control. By analyzing the measured motion parameters of the floating offshore wind turbine foundation, the control module autonomously determines the TLCD loop unit to be started according to the swing direction of the floating offshore wind turbine foundation, and determines to start an air-control module or liquid-control module of the TLCD loop unit according to the swing frequency of the floating offshore wind turbine foundation, as well as the resistance value of a slide rheostat in an air-control module or the rotational speed of motors of water-turbine sets in a liquid-control module.

### TECHNICAL FIELD

The present invention belongs to the technical field of offshore wind power, and relates to an active anti-rolling control technology for a floating offshore wind turbine in offshore deep sea, and particularly relates to an air-liquid dual control anti-rolling control system for a floating offshore wind turbine in offshore deep sea.

### BACKGROUND

Offshore wind energy has wide distribution range, long effective time and good ecological benefits, and is an important marine renewable energy. A floating offshore wind turbine (FOWT) is the core equipment for wind power development in offshore deep sea. The floating offshore wind turbine has high structure, high center of gravity and low rigidity, and a core unit (i.e., a wind rotor) is located at the top of a tower, and a floating foundation is easy to move under the action of an offshore wind-wave environment, thereby resulting in great swing at the top of the tower, ultimately seriously affecting the output power and the power generation quality of the wind rotor, damaging the power generation income of the floating offshore wind turbine and even leading to safety risks. Therefore, it is very important to ensure the stability of the floating foundation under the wind-wave action for the power generation income and the operation safety of the floating offshore wind turbine.

A tuned liquid column damper (TLCD) is an anti-roll technique which can be used for the motion control of the floating offshore wind turbine. The traditional TLCD mainly uses liquid column vibration in a U-tube to generate an applied force opposite to external load on the structure, and generates damping through a throttle or orifice in the tube to dissipate the energy of structural vibration. Different liquid column lengths are corresponding to specific natural vibration frequencies. When the natural vibration frequency reaches the tuning frequency and a damping ratio reaches the best state, the TLCD can bring the best damping effect for the structure.

However, after the scale, liquid capacity and energy dissipation structure form of the traditional passive TLCD are determined, the natural oscillation frequency and the energy dissipation rate of the liquid column are determined accordingly, resulting in that the effective anti-roll effect is mainly concentrated in a narrow frequency bandwidth near the natural oscillation frequency of the TLCD liquid column (Moaleji and Greig. On the development of ship anti-roll tanks, Ocean Engineering, 2007, 34:103-121). However, for the working conditions outside the effective frequency bandwidth range, the traditional TLCD anti-roll effect is limited, and may even deteriorate the motion performance of the floating foundation. The floating offshore wind turbine is moored in the offshore deep sea throughout the year. The experienced wave frequency bandwidth is large, wave frequency components are complex and the borne wave load is large, so an anti-roll system is required to respond quickly in a wider wave frequency range, so as to realize the effective control of the motion of the floating foundation.

The present invention aims to propose an activated anti-rolling control system for a floating offshore wind turbine for sea states of wide frequency bandwidth in offshore deep sea. A plurality of closed TLCD loop units are constructed among stand columns, a pontoon and box girders of a floating offshore wind turbine foundation, and the liquid in each TLCD loop unit is half filled. An air-turbine set is arranged in an air tube of each TLCD loop unit, and a water-turbine set is arranged in a liquid tube. When the swing frequency of the floating foundation is higher than the natural vibration frequency of the liquid column in the TLCD loop unit, the liquid flow in the liquid tube is accelerated through the water-turbine set to increase the vibration frequency of the liquid column in the TLCD loop unit. When the swing frequency of the floating foundation is less than the natural vibration frequency of the TLCD, the airflow and the electricity generation energy consumption are blocked by rotating the air-turbine set, to reduce the vibration frequency of the liquid column in the TLCD loop unit. Thus, the effective frequency bandwidth of the TLCD is widened. At the same time, the electricity generated by the air-turbine set can be stored to support the power demand of the water-turbine set and reduce the electricity consumption of a measurement and control unit. In addition, by designing a control strategy, an optimal TLCD loop unit can be selected autonomously for operation according to the swing direction and frequency of the floating foundation.

### SUMMARY

The purpose of the present invention is to provide an air-liquid dual control anti-rolling control system for a floating offshore wind turbine in offshore deep sea.

The technical solution of the present invention is as follows:

An air-liquid dual control anti-rolling control system for a floating offshore wind turbine in offshore deep sea is provided, and a floating offshore wind turbine is mainly composed of a wind turbine structure 1, a floating foundation 2 and a mooring system 6, as shown in FIG. 1. The floating foundation 2 is composed of stand columns 3, a pontoon 4 and box girders 5; the tops of the three stand columns 3 are connected at equal angles by three box girders 5, and the bottoms of the three stand columns 3 are connected in pairs by the pontoon 4 to form a triangle; the mooring system 6 is connected to the pontoon 4, and the floating foundation 2 is anchored to a water bottom; and the wind turbine structure 1 is installed on one stand column 3 of the floating foundation 2. The present invention aims to provide an air-liquid dual control anti-rolling control system installed inside the structure of the floating foundation 2, and application objects are not limited to a three-column floating offshore wind turbine.

The air-liquid dual control anti-rolling control system for the floating offshore wind turbine in offshore deep sea is mainly composed of an equipment compartment 21 and three closed TLCD loop units 8; the equipment compartment 21 is arranged above the box girders 5; and each TLCD loop unit 8 mainly forms a closed loop by a liquid tank 14, an air tube 15 and a liquid tube 17 and is embedded into the structure of the floating foundation 2.

A measurement and control unit 7 is arranged in the equipment compartment 21; the measurement and control unit 7 comprises a motion measurement module 10, a control module 9, a slide rheostat 19 and a storage battery set 11; the storage battery set 11 supplies power for the motion measurement module 10 and the control module 9; the motion measurement module 10 is a sensor containing swing motion data for measuring the floating foundation 2, and the motion data comprises attitudes, angular velocity and frequency; and the motion data measured by the motion measurement module 10 is inputted to the control module 9, and one TLCD loop unit 8 is activated by the control module 9 to work.

Two liquid tanks 14 are installed inside each stand column 3 of the floating foundation 2, and the two liquid tanks 14 form a cylindrical structure; two adjacent liquid tanks 14 in two adjacent stand columns 3 are communicated to form a closed loop through the liquid tubes 17 in the pontoon 4 and the air tubes 15 in the box girders 5; liquid is filled in the liquid tanks 14 and the liquid tubes 17, and the filling amount of the liquid in the liquid tanks 14 is determined according to the preset natural vibration frequency of liquid columns in the TLCD loop units 8.

Each air tube 15 comprises an air-control module 12; the air-control module 12 is mainly composed of an air-turbine set 18 and a valve 20; the air-turbine set 18 converts kinetic energy of gas in the air tube 15 into electrical energy to control the flow speed of the gas, and the generated electrical energy is stored in the storage battery set 11 in the measurement and control unit 7; the valve 20 is arranged near the air-turbine set 18, and the opening and closing state is determined by the control module 9 in the measurement and control unit 7; after the valve 20 is closed, the gas in the air tube 15 cannot flow; the air-turbine set 18, the slide rheostat 19 and the storage battery set 11 are connected to form a closed circuit; the control module 9 controls the rotational speed of the air-turbine set 18 by adjusting the resistance value of the slide rheostat 19; and the air-turbine set 18 with different rotational speeds generates damping of different degrees for the gas flow in the air tube 15 to generate different degrees of obstruction effects on the airflow in the air tube 15.

Each liquid tube 17 comprises a liquid-control module 13; the liquid-control modules 13 are two reversely installed water-turbine sets 16; the water-turbine sets 16 have programmable motors, and the rotational speed of the motors is adjusted by the control module 9; the storage battery set 11 in the measurement and control unit 7 supplies power for the motors of the water-turbine sets 16; and the two water-turbine sets 16 work alternately under the instructions of the control module 9 to drive the liquid in the liquid tubes 17 to generate oscillating flow.

As shown in FIG. 4, the working process of the air-liquid dual control anti-rolling control technology is as follows:

The motion measurement module 10 measures the motion data of the floating foundation 2 in real time and inputs the measured data into the control module 9. When the floating foundation 2 is in a stationary state, the control module 9 keeps the valve 20 of each TLCD loop unit 8 in a closed state. When the floating foundation 2 is in a motion state, the control module 9 analyzes an axis of rotation of the swing motion of the floating foundation 2, compares the angle between the liquid tube 17 and the swing axis of rotation in each TLCD loop unit 8, selects the TLCD loop unit 8 whose angle is closest to 90° between the liquid tube 17 and the swing axis of rotation and opens the valve 20 of the TLCD loop unit 8.

The control module 9 further analyzes the swing frequency of the floating foundation 2. If the swing frequency of the floating foundation 2 is lower than the natural vibration frequency of the liquid column in the TLCD loop unit 8 without control, then the air-control module 12 of the TLCD loop unit 8 is started; otherwise, the liquid-control module 13 of the TLCD loop unit 8 is started.

If the air-control module 12 is started, the control module 9 sets the resistance value of the slide rheostat 19 according to the swing frequency of the floating foundation 2, and the air-turbine set 18 converts the air kinetic energy in the air tube 15 into electric energy to reduce the vibration frequency of the air in the air tube 15, so that the vibration frequency of the liquid column 22 is reduced to the motion frequency of the floating foundation 2. The electrical energy generated by the air-turbine set 18 is stored in the storage battery set 11.

If the liquid-control module 13 is started, the control module 9 controls the water-turbine sets 16 to reach predetermined rotational speed according to the motion frequency of the floating foundation 2. The storage battery set 11 supplies power for the water-turbine sets 16, so that the water-turbine sets 16 push the liquid to form reciprocating oscillating flow in the liquid tube 17, the vibration frequency of the liquid column 22 is increased to the swing frequency of the floating foundation 2 and the motion direction of the liquid in the liquid tube 17 is always opposite to the motion direction of the liquid tube 17.

Under different swing frequencies of the floating foundation 2, for the resistance value selected for the slide rheostat 19 or the rotational speed value selected for the motors of the water-turbine sets 16 in the liquid-control module 13, an optimal value is determined in advance in a design stage by conventional analysis methods such as theoretical calculation, numerical simulation of computational fluid mechanics method or scaled test of rocking table physical model.

The present invention has the following beneficial effects:

(1) The technology regulates the natural vibration frequency of the liquid columns of the TLCD loop units in the floating offshore wind turbine foundation in offshore deep sea by active control, so as to quickly realize the effective suppression of the swing motion of the floating foundation within a wider wave frequency range.

(2) The technology reduces the motion amplitude of the floating offshore wind turbine foundation in waves, improves the operating conditions of a wind rotor at the top of a tower, and is conducive to extending the working time and the service life of the wind rotor, thereby increasing the power generation income of the floating offshore wind turbine and reducing the maintenance cost.

(2) After the technology is used, it avoids increasing the strength and quantity of the mooring system or increasing the displacement of the floating offshore wind turbine foundation for the anti-rolling purpose of the floating offshore wind turbine foundation, and reduces the construction cost of the floating offshore wind turbine in offshore deep sea.

(3) The technology converts the kinetic energy of the gas into electrical energy and stores the electrical energy in the storage battery set while controlling the airflow motion in the TLCD loop units through the air-turbine sets. The electrical energy stored by the storage battery set can support the working electricity demand of the motion measurement module and the control module in the measurement and control unit, and the water-turbine sets in the TLCD loop units, so as to realize the self-sufficiency of the electricity of the measurement and control unit and the TLCD loop units, without additional consumption of the electrical energy of the floating offshore wind turbine foundation in offshore deep sea, and without affecting the integration of a wind farm.

(4) The TLCD loop units and the measurement and control unit of the technology are installed in the original floating offshore wind turbine foundation structure, without affecting the contour design and hydrodynamic property of the floating offshore wind turbine.

(5) The technology has universality, the designed TLCD loop units are independent of each other, and the start and stop of each TCLD loop unit is entirely coordinated and scheduled by the control module, which is easy to expand. The number of the TLCD loop units based on the technical principle is not limited to three, nor limited to the three-column floating offshore wind turbine foundation, which can be applied to four-column or more-column floating offshore wind turbine foundations.

(6) The technology can realize intelligent autonomous control. By analyzing the measured motion parameters of the floating offshore wind turbine foundation, the control module autonomously determines the TLCD loop unit to be started according to the swing direction of the floating offshore wind turbine foundation, and determines to start the air-control module or liquid-control module of the TLCD loop unit according to the swing frequency of the floating offshore wind turbine foundation, as well as the resistance value of the slide rheostat or the rotational speed of the motors of the water-turbine sets in the liquid-control module.

(7) The technology has simple structure, easy installation, detachability, easy replacement and convenient use.

### DESCRIPTION OF DRAWINGS

FIG. 1 is a structural composition schematic diagram of a typical three-column floating offshore wind turbine.

FIG. 2 is an arrangement diagram of a TLCD loop unit in a floating foundation.

FIG. 3 is a structure diagram of an air-liquid dual control anti-rolling control system.

FIG. 4 is a control logic diagram of an air-liquid dual control anti-rolling control system.

In the figures: 1 wind turbine structure; 2 floating foundation; 3 stand column; 4 pontoon; 5 box girder; 6 mooring system; 7 measurement and control unit; 8 TLCD loop unit; 9 control module; 10 motion measurement module; 11 storage battery set; 12 air-control module; 13 liquid-control module; 14 liquid tank; 15 air tube; 16 water-turbine set; 17 liquid tube; 18 air-turbine set; 19 slide rheostat; 20 valve; 21 equipment compartment; 22 liquid column.

### DETAILED DESCRIPTION

The present invention is further described below in detail in combination with the drawings and specific embodiments. The following embodiments and the drawings are used for illustrating the present invention, not limiting the scope of the present invention.

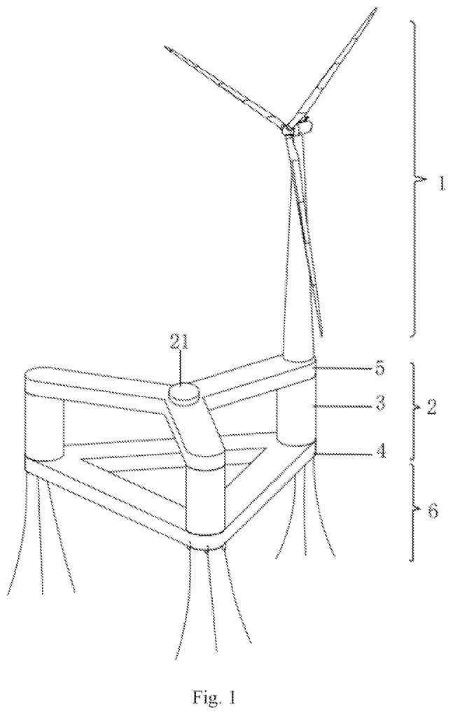

As shown in FIG. 1, by taking a three-column floating offshore wind turbine as an example, the floating offshore wind turbine is composed of a wind turbine structure 1, a floating foundation 2 (comprising stand columns 3, a pontoon 4 and box girders 5) and a mooring system 6. The outline dimensions of the floating offshore wind turbine have been designed in advance. For example, the stand column is diameter 10 m×height 20 m, the pontoon has the dimension of 34 m×10 m×3 m, and the box girder has the dimension of 40 m×10 m×4 m.

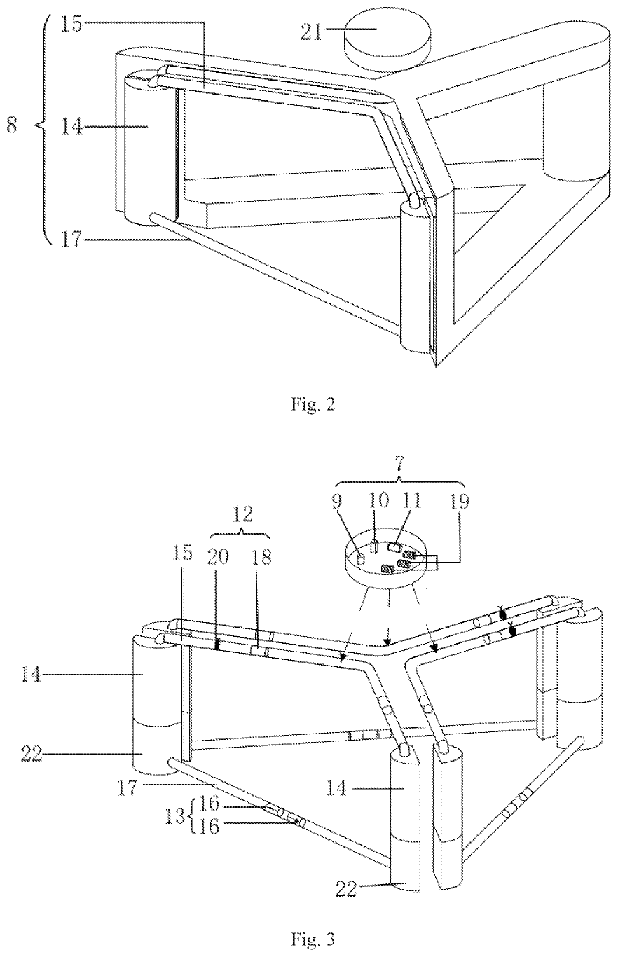

As shown in FIG. 2, on the basis of ensuring the strength of the structure, the internal spaces of the stand columns 3 are fully used, and two isolated liquid tanks 14 are arranged in each stand column 3. A liquid tube 17 is paved in the pontoon 4, communicated with the lower ends of two nearest liquid tanks 14 in the two adjacent stand columns 3, and communicated with the upper ends of the two liquid tanks 14 in box girders 5 by using the air tube 15 to form a closed loop. The dimension of the liquid tanks 14, the diameter of the liquid tube 17 and the depth of liquid 22 in the liquid tanks 14 need to be specifically determined by conventional numerical simulation of computational fluid dynamics and physical model tests in the design stage to ensure that the natural oscillation frequency of the liquid columns 22 in the TLCD loop units is consistent with the main wave frequency of a target sea area. In the present embodiment, two liquid tanks 14 with semicircular cross sections are adopted; the diameter of a semicircle is 6 m; the height of the liquid tanks 14 is 17 m; the depth of liquid is 5 m; the bottoms of the liquid tanks 14 are 1 m from the bottom surface outside the stand columns; and the spacing between the vertical planes of two liquid tanks 14 is 1 m; the liquid tube 17 is a circular tube with a diameter of 2 m; the cross-sectional area of the air tube 15 should be as large as possible, and a circular tube with a diameter of 1 m is used.

As shown in FIG. 3, two reverse propulsion water-turbine sets 16 are installed on a middle section in each liquid tube 17. The water-turbine sets 16 adopt motors that can control the rotational speed. The selection of the water-turbine sets 16 must ensure that the water-turbine sets can efficiently push water in the liquid tube 17 to move. An air-turbine set 18 is installed on the middle section in the air tube 15, and the selection of the air-turbine set 18 shall ensure that the air-turbine set can effectively produce different degrees of obstruction to the gas in the air tube 15 under different rotational speed conditions. A valve 20 is arranged in the air tube 15. The concrete form of selection of the valve 20 is not limited, and the opening and closing state shall be determined by the control module 9 and after the valve 20 is closed, the gas in the air tube 15 shall be ensured not to flow.

A watertight equipment compartment 21 is arranged above the box girders 5 for placing a motion measurement module 10, the control module 9, a storage battery set 11 and a slide rheostat 19 of a measurement and control unit 7. The motion measurement module 10 selects a sensor that can measure and output motion data such as attitude, angular velocity and frequency of swing motion of the floating foundation. The specific model is not limited. In the present embodiment, a three-axis gyroscope is used. The selection of the storage battery set 11 is not limited. In the present embodiment, a lead-acid storage battery is used, and the total capacity of the storage battery set 11 must achieve that the water-turbine sets 16 reach a specified working duration (e.g., more than 6 hours) under the maximum power condition. The specific circuit design of the control module 9 and the type and form of the components of a master control board/controller/actuator are not limited in order to complete all the control functions of an air-liquid dual control anti-rolling control system. In the present embodiment, a microcontroller unit MCU and a programmable logic controller PLC are used in the present embodiment.

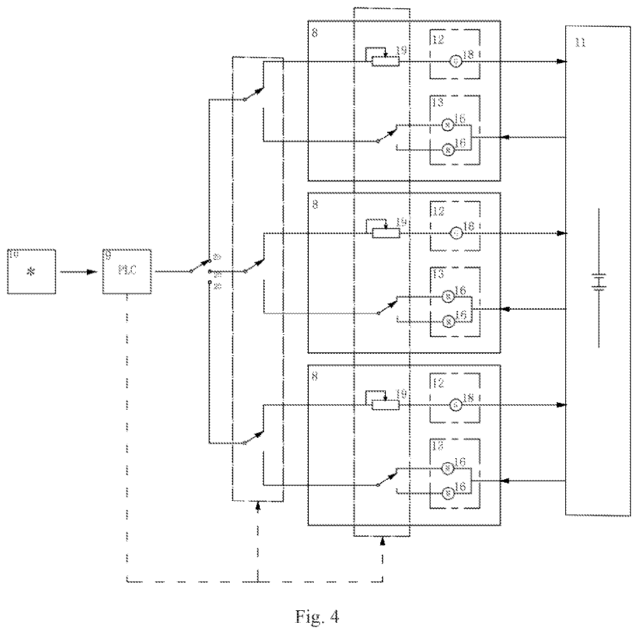

The working principle of the air-liquid dual control anti-rolling control system is shown in FIG. 4. The motion measurement module 10 measures the motion parameters of the floating foundation in real time and inputs the measured data into the control module 9. When the floating foundation 2 is in a stationary state, the control module 9 keeps the valve 20 of each TLCD loop unit 8 in a closed state. When the floating foundation 2 is in a motion state, the control module 9 analyzes an axis of rotation of the swing motion of the floating foundation 2, compares the angle between the liquid tube 17 and the swing axis of rotation in each TLCD loop unit 8, selects the TLCD loop unit 8 whose angle is closest to 90° between the liquid tube 17 and the swing axis of rotation and opens the valve 20 of the TLCD loop unit 8.

The control module 9 further analyzes the swing frequency of the floating foundation 2. If the swing frequency of the floating foundation is higher than the natural oscillation frequency of the liquid 22 in the TLCD loop unit without control, then the air-control module of the TLCD loop unit is started; otherwise, the liquid-control module of the TLCD loop unit is started.

When the air-control module 12 is started, the control module 9 sets the resistance value of the slide rheostat 19 according to the motion frequency of the floating foundation 2, and controls the rotational speed of the air-turbine set 18 to achieve the effect of reducing the vibration frequency of the liquid 22 by obstructing the motion of air in the air tube 15. Meanwhile, the air-turbine set 18 converts the air kinetic energy in the air tube 15 into electric energy, and the electrical energy generated by the air-turbine set 18 is stored in the storage battery set 11.

When the liquid-control module 13 is started, the control module 9 starts the water-turbine sets 16 which can push the liquid columns 22 in the liquid tube 17 in the direction opposite to the motion direction of the liquid tube 17 according to the motion direction of the liquid tube 17. Meanwhile, the control module 9 controls the water-turbine sets 16 to reach predetermined rotational speed according to the motion frequency of the floating foundation 2. The storage battery set 11 supplies power for the water-turbine sets 16. Under the interactive push of the two water-turbine sets 16, the liquid 22 forms reciprocating oscillating flow in the liquid tube 17, and the motion direction of the liquid 22 in the liquid tube 17 is always opposite to the motion direction of the liquid tube 17.

The resistance value selected for the slide rheostat 19 by the control module 9 or the rotational speed value set for the motors of the water-turbine sets 16 in the liquid-control module 13 shall be determined in advance in the design stage by conventional analysis methods such as numerical simulation of computational fluid mechanics method or scaled test of rocking table physical model. After a comparison table between the swing frequency of the floating foundation 2 and the optimal resistance value of the slide rheostat 19 or the optimal rotational speed value of the motors of the water-turbine sets 16 is formed in the design stage, the control module 9 selects the resistance value of the slide rheostat 19 or the rotational speed value of the motors of the water-turbine sets 16 in the liquid-control module 13 by looking up the table in the working process.

The product design of the present invention should fully consider the following factors:

(1) For the floating offshore wind turbine foundations with different dimensions, the dimension of the liquid tanks 14, the diameter of the liquid tube 17 and the depth of liquid columns 22 in the liquid tanks 14 need to be specifically determined by conventional numerical simulation of computational fluid dynamics and physical model tests in the design stage to ensure that the natural vibration frequency of the liquid columns 22 in the TLCD loop units is consistent with the main swing frequency of the floating foundation 2.

1. An air-liquid dual control anti-rolling control system for a floating offshore wind turbine in offshore deep sea, which is mainly composed of an equipment compartment (21) and three closed TLCD loop units (8), wherein the equipment compartment (21) is arranged above box girders (5); and each TLCD loop unit (8) mainly forms a closed loop by a liquid tank (14), an air tube (15) and a liquid tube (17) and is embedded into the structure of a floating foundation (2);
a measurement and control unit (7) is arranged in the equipment compartment (21); the measurement and control unit (7) comprises a motion measurement module (10), a control module (9), a slide rheostat (19) and a storage battery set (11); the storage battery set (11) supplies power for the motion measurement module (10) and the control module (9); the motion measurement module (10) is a sensor containing swing motion data for measuring the floating foundation (2), and the motion data comprises attitudes, angular velocity and frequency; the motion data measured by the motion measurement module (10) is inputted to the control module (9), and one TLCD loop unit (8) is activated by the control module (9) to work; two liquid tanks (14) are installed inside each stand column (3) of the floating foundation (2), and the two liquid tanks (14) form a cylindrical structure; two adjacent liquid tanks (14) in two adjacent stand columns (3) are communicated to form a closed loop through the liquid tubes (17) in the pontoon (4) and the air tubes (15) in the box girders (5); liquid is filled in the liquid tanks (14) and the liquid tubes (17), and the filling amount of the liquid in the liquid tanks (14) is determined according to the preset natural vibration frequency of liquid columns (22) in the TLCD loop units (8);
each air tube (15) comprises an air-control module (12); the air-control module (12) is mainly composed of an air-turbine set (18) and a valve (20); the air-turbine set (18) converts kinetic energy of gas in the air tube (15) into electrical energy to control the flow speed of the gas, and the generated electrical energy is stored in the storage battery set (11) in the measurement and control unit (7); the valve (20) is arranged near the air-turbine set (18), and the opening and closing state is determined by the control module (9) in the measurement and control unit (7); after the valve (20) is closed, the gas in the air tube (15) cannot flow; the air-turbine set (18), the slide rheostat (19) and the storage battery set (11) are connected to form a closed circuit; the control module (9) controls the rotational speed of the air-turbine set (18) by adjusting the resistance value of the slide rheostat (19); and the air-turbine set (18) with different rotational speeds generates damping of different degrees for the gas flow in the air tube (15) to generate different degrees of obstruction effects on the airflow in the air tube (15);
each liquid tube (17) comprises a liquid-control module (13); the liquid-control modules (13) are two reversely installed water-turbine sets (16); the water-turbine sets (16) have programmable motors, and the rotational speed of the motors is adjusted by the control module (9); the storage battery set (11) in the measurement and control unit (7) supplies power for the motors of the water-turbine sets (16); and the two water-turbine sets (16) work alternately under the instructions of the control module (9) to drive the liquid in the liquid tubes (17) to generate oscillating flow.

2. The air-liquid dual control anti-rolling control system for the floating offshore wind turbine in offshore deep sea according to claim 1, wherein
the floating offshore wind turbine is mainly composed of a wind turbine structure (1), a floating foundation (2) and a mooring system (6); the floating foundation (2) is composed of stand columns (3), a pontoon (4) and box girders (5); the tops of the three stand columns (3) are connected at equal angles by three box girders (5), and the bottoms of the three stand columns (3) are connected in pairs by the pontoon (4) to form a triangle; the mooring system (6) is connected to the pontoon (4), and the floating foundation (2) is anchored to a water bottom; and the wind turbine structure (1) is installed on one stand column (3) of the floating foundation (2).
